(19) United States
(12) Patent Application Publication
(10) Pub. No.: US 2024/0344691 A1
(43) Pub. Date: Oct. 17, 2024

(54) UMBRELLA HANDLE LAMP CAPABLE OF CARRYING OUT PROJECTION

(71) Applicant: Wuhu Yunianmiaoke Culture Creative Co.,Ltd., Wuhu (CN)

(72) Inventors: Qi YAN, Wuhan (CN); Ling MEI, Wuhan (CN); Nian LI, Wuhan (CN); Yang GUI, Hubei Province (CN); Yuyang LU, Guangzhou (CN)

(21) Appl. No.: 18/613,842

(22) Filed: Mar. 22, 2024

(30) Foreign Application Priority Data
Apr. 12, 2023 (CN) 202320792416.6

(51) Int. Cl. F21V 33/00; F21L 14/00; F21V 5/00; F21V 23/04

(52) U.S. Cl. CPC F21V 33/0004; F21L 14/00; F21V 5/008; F21V 23/04

(57) ABSTRACT

An umbrella handle lamp capable of carrying out projection includes an umbrella handle, a lamp assembly and a connecting assembly. The lamp assembly being movably arranged at the tail of the umbrella handle through the connecting assembly. The umbrella handle lamp capable of carrying out projection also includes a projection lens group and a fixed assembly. The lamp assembly includes a shell. The upper part of the shell is provided with a battery cabin for batteries to enter. A lower end face of the shell is provided with a lens cabin for the projection lens group to enter. The projection lens group is connected with the shell through the fixed assembly. The projection lens group is arranged in front of the bulb, so that the projection patterns can be formed at the irradiation position when an umbrella is used.

### CROSS-REFERENCE TO RELATED APPLICATIONS

The application claims priority of Chinese patent application CN2023207924166, filed on Apr. 12, 2023, which is incorporated herein by reference in its entireties.

### TECHNICAL FIELD

The present disclosure belongs to the technical field of lighting equipment, in particular to an umbrella handle lamp capable of carrying out projection.

### BACKGROUND

As we all know, umbrellas can be seen everywhere in people's life, and are various in types and shapes. The umbrellas are mainly used for sun protection and rain protection. On rainy nights, it is obviously inconvenient for travelers to carry both umbrellas and lighting tools.

However, most of the existing umbrellas do not have the function of lighting, and for a few umbrellas with the function of lighting, the lamp is only integrated in the handle, which can only play the function of lighting. However, in reality, many merchants give away umbrellas printed with own products or trademarks for promotion, but the way of simply printing the products or trademarks on the umbrella surface has fallen behind the times. In order to improve the advertising efficiency, the lighting lamp on the umbrella handle is improved, and the irradiated light can form preset trademarks or patterns, so that the advertising effect of the gift umbrella is better.

### SUMMARY

Aiming at the problems, the present disclosure provides an umbrella handle lamp capable of carrying out projection. A projection lens group is arranged in front of the lamp bulb, so that the lamp bulb can illuminate the projection lens group to form required projection at the irradiation place to achieve the advertising effect.

Specific technical schemes are as follows.

An umbrella handle lamp capable of carrying out projection includes an umbrella handle, a lamp assembly and a connecting assembly, and the lamp assembly being movably arranged at the tail of the umbrella handle through the connecting assembly, wherein the umbrella handle lamp capable of carrying out projection also includes a projection lens group and a fixed assembly, the lamp assembly includes a shell, the upper part of the shell is provided with a battery cabin for batteries to enter, a lower end face of the shell is provided with a lens cabin for the projection lens group to enter, and the projection lens group is connected with the shell through the fixed assembly.

The umbrella handle lamp capable of carrying out projection described above also includes following features. The connecting assembly includes a fixed ring, a screw-in cylinder and a limit ring, an annular groove is formed in a lower end of the umbrella handle, a side wall of the annular groove is provided with an internal thread, an inner side wall of the screw-in cylinder is provided with a thread adapted to the annular groove, the screw-in cylinder is arranged on a top end face of the fixed ring, the limit ring is arranged at the lower part of an inner side wall of the fixed ring, and when the screw-in cylinder completely enters the annular groove, the limit ring abuts against the shell, so that the limit ring is fixed in an accommodating cavity in the tail of the umbrella handle.

The scheme has the beneficial effect that the lamp assembly can be fixed in the accommodating cavity through the cooperation of the fixed ring and the screw-in cylinder.

The umbrella handle lamp capable of carrying out projection described above also includes following features. The lamp assembly also includes a circuit board and a lamp bulb, the circuit board is arranged at the upper part of the lens cabin, the lamp bulb is electrically connected with positive and negative conducting strips in the battery cabin through the circuit board, a top surface of the circuit board is provided with a button switch, an abutting plate is arranged above the circuit board, the abutting plate is fixedly connected with an inner side wall of the shell, and when the circuit board moves upward, the button switch can be pressed through the abutting plate.

The scheme has the beneficial effect that when the projection lens group is pushed by a user, the circuit board is arranged at the upper end through the projection lens group until the button switch is switched on, the lamp bulb is powered on and turned on, and the button switch can be switched off by pushing the projection lens group again, so that the lamp bulb is powered off and turned off.

The umbrella handle lamp capable of carrying out projection described above also includes following features. The projection lens group includes a lens cavity, a first lens, a second lens, third lenses, a slide and a plurality of limit blocks, the first lens, the second lens, the slide and the third lenses are arranged in the lens cavity from top to bottom, the first lens, the second lens, the third lenses and the slide are respectively clamped by the limit blocks in pairs to be fixed in the lens cavity, the fixed assembly is arranged on an outer side wall of the lens cavity, and a neck capable of being adapted to the fixed assembly is formed in the fixed assembly corresponding to the inner side wall of the shell.

The scheme has the beneficial effect that the first lens and the second lenses work together to convert light emitted by the lamp bulb into parallel light, so that the parallel light passes through the slide, and the third lenses are used for converging and emitting the parallel light passing through the slide, so that clear projection patterns are formed at the irradiation place.

The umbrella handle lamp capable of carrying out projection described above also includes following features. The fixed assembly includes a plurality of hooks, grooves corresponding to the hooks in numbers are formed in the outer side wall of the lens cavity, the hooks are arranged in the grooves, when the lens cavity enters the shell, the inner side wall of the shell squeezes the hooks to retract the grooves, and when the lens cavity moves in place, the hooks directly face the hooks, and the hooks rebound under the action of own elastic force and are mutually clamped with the hooks.

The scheme has the beneficial effect that when the lens cavity completely enters the lens cabin, the hook and the neck are clamped with each other to prevent the user from taking off the lens group.

In conclusion, the scheme has the following beneficial effects.

In the umbrella handle lamp capable of carrying out projection provided by the present disclosure, the projection lens group is arranged in front of the bulb, so that the projection patterns can be formed at the irradiation position when an umbrella is used. The fixed assembly is used to prevent the user from taking off the projection lens group, so that the advertising efficiency is improved. The umbrella handle lamp capable of carrying out projection provided by the present disclosure has the effect of improving the advertising efficiency through the projection patterns.

### BRIEF DESCRIPTION OF THE DRAWINGS

FIG. 1 is a normal cross-sectional structural schematic diagram of an umbrella handle lamp capable of carrying out projection in the present disclosure.

FIG. 2 is an enlarged structural schematic diagram of part A in FIG. 1 in the present disclosure.

FIG. 3 is a normal cross-sectional structural schematic diagram of a connecting assembly of an umbrella handle lamp capable of carrying out projection in the present disclosure.

### DETAILED DESCRIPTION OF THE EMBODIMENTS

The accompanying drawings in the embodiment of the present disclosure are combined, The technical scheme in the embodiment of the present disclosure is clearly and completely described, Obviously, the described embodiment is only a part of the embodiment of the present disclosure, but not all embodiments are based on the embodiment of the present disclosure, and all other embodiments obtained by ordinary technicians in the field on the premise of not doing creative work belong to the protection range of the present disclosure.

It is to be noted that the embodiments in present disclosure and the features in the embodiments may be combined with one another without conflict.

The present disclosure will now be described below in detail with reference to the embodiments, and should not be construed as limiting the embodiments of the present disclosure.

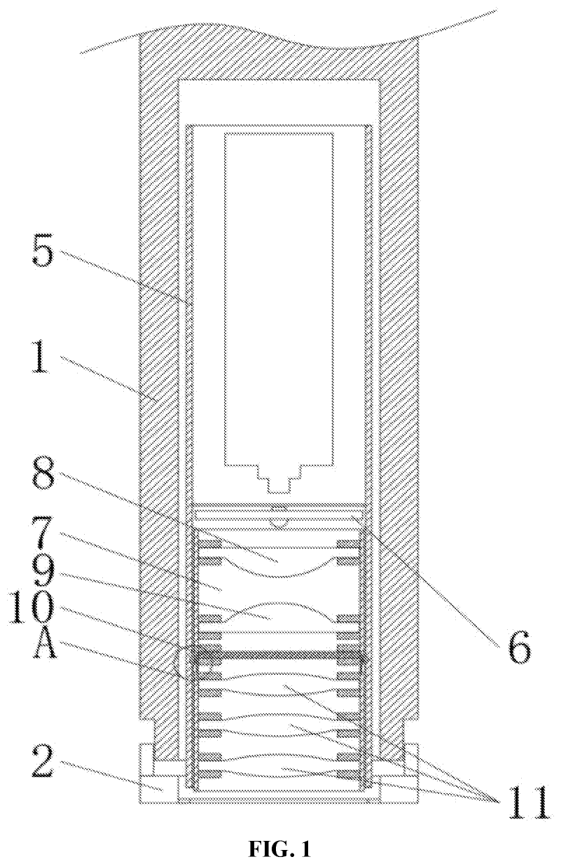

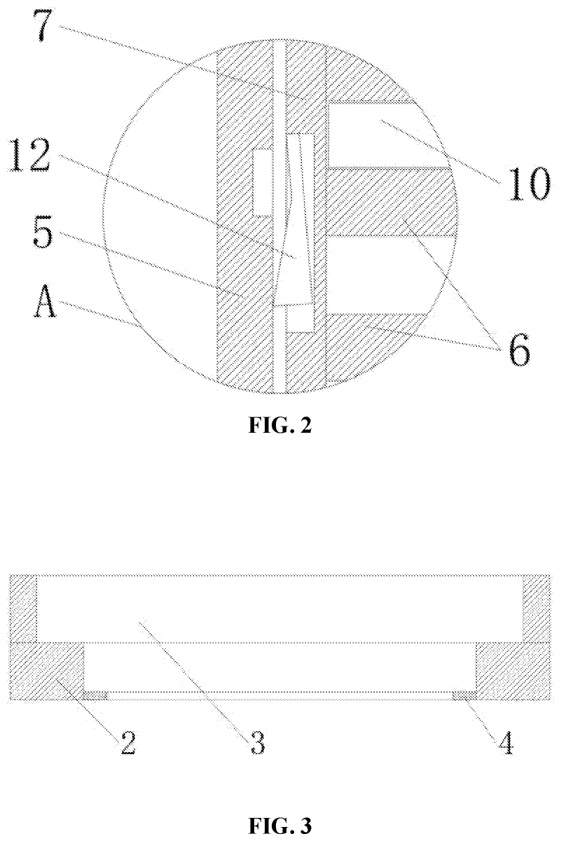

FIG. 1 is a normal cross-sectional structural schematic diagram of an umbrella handle lamp capable of carrying out projection in the present disclosure. FIG. 2 is an enlarged structural schematic diagram of part A in FIG. 1 in the present disclosure. FIG. 3 is a normal cross-sectional structural schematic diagram of a connecting assembly of an umbrella handle lamp capable of carrying out projection in the present disclosure. As shown in FIG. 1, FIG. 2 and FIG. 3, an umbrella handle lamp capable of carrying out projection provided by the embodiment includes an umbrella handle 1, a lamp assembly and a connecting assembly. The lamp assembly is movably arranged at the tail of the umbrella handle 1 through the connecting assembly. The umbrella handle lamp capable of carrying out projection also includes a projection lens group and a fixed assembly. The lamp assembly includes a shell 5. The upper part of the shell 5 is provided with a battery cabin for batteries to enter. A lower end face of the shell 5 is provided with a lens cabin for the projection lens group to enter. The projection lens group is connected with the shell 5 through the fixed assembly.

In the embodiment, the connecting assembly includes a fixed ring 2, a screw-in cylinder and a limit ring 4. An annular groove is formed in a lower end of the umbrella handle 1. A side wall of the annular groove is provided with an internal thread. An inner side wall of the screw-in cylinder is provided with a thread adapted to the annular groove. The screw-in cylinder is arranged on a top end face of the fixed ring 2. The limit ring 4 is arranged at the lower part of an inner side wall of the fixed ring 2. When the screw-in cylinder completely enters the annular groove, the limit ring 4 abuts against the shell 5, so that the limit ring 4 is fixed in an accommodating cavity in the tail of the umbrella handle 1.

In the embodiment, the lamp assembly also includes a circuit board 6 and a lamp bulb. The circuit board 6 is arranged at the upper part of the lens cabin. The lamp bulb is electrically connected with positive and negative conducting strips in the battery cabin through the circuit board 6. A top surface of the circuit board 6 is provided with a button switch. An abutting plate is arranged above the circuit board 6. The abutting plate is fixedly connected with an inner side wall of the shell 5. When the circuit board 6 moves upward, the button switch can be pressed through the abutting plate.

What needs illustration is that the circuit board 6 is arranged at the upper part of the lens cabin, and can move slightly only at the upper part of the lens cabin.

In the embodiment, the projection lens group includes a lens cavity 7, a first lens 8, a second lens 9, third lenses 11, a slide 10 and a plurality of limit blocks. The first lens 8, the second lens 9, the slide 10 and the third lenses 11 are arranged in the lens cavity 7 from top to bottom. The first lens 8, the second lens 9, the third lenses 11 and the slide 10 are respectively clamped by the limit blocks in pairs to be fixed in the lens cavity 7. The fixed assembly is arranged on an outer side wall of the lens cavity 7. A neck capable of being adapted to the fixed assembly is formed in the fixed assembly corresponding to the inner side wall of the shell 5.

What needs illustration is that the slide 10 is provided with patterns needing to be projected, and after light passes through the slide 10, projection patterns can remain at projection positions.

What needs illustration is that the third lenses 11 include three convex lenses and are used for converging and emitting parallel light passing through the slide 10, so that the patterns on the slide 10 are enlarged and projected.

In the embodiment, the fixed assembly includes a plurality of hooks 12. Grooves corresponding to the hooks 12 in numbers are formed in the outer side wall of the lens cavity 7. The hooks 12 are arranged in the grooves. When the lens cavity 7 enters the shell 5, the inner side wall of the shell 5 squeezes the hooks 12 to retract the grooves. When the lens cavity 7 moves in place, the hooks 12 directly face the hooks, and the hooks 12 rebound under the action of own elastic force and are mutually clamped with the hooks.

According to the working principle, the lens cavity 7 is sent into the lens cabin. When the lens cavity 7 enters the lens cabin, the inner side wall of the shell 5 extrudes the hook 12 to be bent and retracted into the groove. When the lens cavity 7 moves in place, the hook 12 directly faces the neck, and the hook 12 rebounds under own elastic force to be mutually clamped with the groove. The shell 5 is inserted into the accommodating cavity and the screw-in ring 3 aligns with the annular groove to be screwed in. When the fixed ring 2 is attached to the umbrella handle 1, the limit ring 4 abuts against the shell 5. At this time, the lens cavity 7 can be driven to move upwards by pressing the third lenses 11. The circuit board 6 is moved upwards, the button switch is switched on, and the lamp bulb is lightened, so that the patterns are projected at the projection position.

The above is only the preferred embodiments of the present disclosure, and is not intended to limit the present disclosure. Any modifications, equivalent replacements and improvements that are made within the spirit and principle of the present disclosure shall fall within the protection scope of the present disclosure.

What is claimed is:

1. An umbrella handle lamp capable of carrying out projection, comprising an umbrella handle (1), a lamp assembly and a connecting assembly, and the lamp assembly being movably arranged at the tail of the umbrella handle (1) through the connecting assembly, wherein the umbrella handle lamp capable of carrying out projection also comprises a projection lens group and a fixed assembly, the lamp assembly comprises a shell (5), the upper part of the shell (5) is provided with a battery cabin for batteries to enter, a lower end face of the shell (5) is provided with a lens cabin for the projection lens group to enter, and the projection lens group is connected with the shell (5) through the fixed assembly.

2. The umbrella handle lamp capable of carrying out projection according to claim 1, wherein the connecting assembly comprises a fixed ring (2), a screw-in cylinder and a limit ring (4), an annular groove is formed in a lower end of the umbrella handle (1), a side wall of the annular groove is provided with an internal thread, an inner side wall of the screw-in cylinder is provided with a thread adapted to the annular groove, the screw-in cylinder is arranged on a top end face of the fixed ring (2), the limit ring (4) is arranged at the lower part of an inner side wall of the fixed ring (2), and when the screw-in cylinder completely enters the annular groove, the limit ring (4) abuts against the shell (5), so that the limit ring (4) is fixed in an accommodating cavity in the tail of the umbrella handle (1).

3. The umbrella handle lamp capable of carrying out projection according to claim 2, wherein the lamp assembly also comprises a circuit board (6) and a lamp bulb, the circuit board (6) is arranged at the upper part of the lens cabin, the lamp bulb is electrically connected with positive and negative conducting strips in the battery cabin through the circuit board (6), a top surface of the circuit board (6) is provided with a button switch, an abutting plate is arranged above the circuit board (6), the abutting plate is fixedly connected with an inner side wall of the shell (5), and when the circuit board (6) moves upward, the button switch can be pressed through the abutting plate.

4. The umbrella handle lamp capable of carrying out projection according to claim 3, wherein the projection lens group comprises a lens cavity (7), a first lens (8), a second lens (9), third lenses (11), a slide (10) and a plurality of limit blocks, the first lens (8), the second lens (9), the slide (10) and the third lenses (11) are arranged in the lens cavity (7) from top to bottom, the first lens (8), the second lens (9), the third lenses (11) and the slide (10) are respectively clamped by the limit blocks in pairs to be fixed in the lens cavity (7), the fixed assembly is arranged on an outer side wall of the lens cavity (7), and a neck capable of being adapted to the fixed assembly is formed in the fixed assembly corresponding to the inner side wall of the shell (5).

5. The umbrella handle lamp capable of carrying out projection according to claim 4, wherein the fixed assembly comprises a plurality of hooks (12), grooves corresponding to the hooks (12) in numbers are formed in the outer side wall of the lens cavity (7), the hooks (12) are arranged in the grooves, when the lens cavity (7) enters the shell (5), the inner side wall of the shell (5) squeezes the hooks (12) to retract the grooves, and when the lens cavity (7) moves in place, the hooks (12) directly face the hooks, and the hooks (12) rebound under the action of own elastic force and are mutually clamped with the hooks.
